(19) United States
(12) Patent Application Publication
(10) Pub. No.: US 2013/0316253 A1
(43) Pub. Date: Nov. 28, 2013

(54) METHOD FOR PRODUCING CATHODE MATERIAL FOR RECHARGEABLE LITHIUM-AIR BATTERIES, CATHODE MATERIAL FOR RECHARGEABLE LITHIUM-AIR BATTERIES AND RECHARGEABLE LITHIUM-AIR BATTERY

(71) Applicants: Fanny J. Barde, Houwaart (BE); Peter G. Bruce, Newport-on-Tay (GB); Stefan A. Freunberger, Graz (AT); Laurence J. Hardwick, Liverpool (GB); Yuhui Chen, St. Andrews (GB)

(72) Inventors: Fanny J. Barde, Houwaart (BE); Peter G. Bruce, Newport-on-Tay (GB); Stefan A. Freunberger, Graz (AT); Laurence J. Hardwick, Liverpool (GB); Yuhui Chen, St. Andrews (GB)

(73) Assignees: THE UNIVERSITY COURT OF THE UNIVERSITY OF ST. ANDREWS, St. Andrews ,Fife (GB); TOYOTA JIDOSHA KABUSHIKI KAISHA, Toyota-shi, Aichi (JP)

(21) Appl. No.: 13/993,999

(22) PCT Filed: Feb. 16, 2011
(86) PCT No.: PCT/JP2011/053888

§ 371 Date: Jul. 10, 2013

(51) Int. Cl. H01M 4/90

(52) U.S. Cl. CPC H01M 4/9083
USPC 429/405; 502/5

(57) ABSTRACT

A method for producing a cathode material for rechargeable lithium-air batteries, which has a cathode catalyst loaded onto carbon, includes: a step of sonicating a mixed solution including a carbon having a specific surface area of 20 to 1,500 m²/g, a surfactant and a solvent, and a step of in situ synthesis of the cathode catalyst by (1) adding a cathode catalyst raw material to the mixed solution and (2) adding a solution containing an oxidant to the mixed solution to cause in situ precipitation of the cathode catalyst onto the carbon, the catalyst having a wire form in which the short axis length is smaller than that of the carbon and is 2 to 50 nm and the long axis length is longer than that of the carbon and is 5 to 200 nm.

### TECHNICAL FIELD

The present invention relates to a method for producing a cathode material for rechargeable lithium-air batteries, a cathode material for rechargeable lithium-air batteries and a rechargeable lithium-air battery.

### BACKGROUND ART

In recent years, with the rapid spread of information-related devices and communication devices such as personal computers, camcorders and cellular phones, it has become important to develop a battery for use as a power source for such devices. In the automobile industry, the development of high-power and high-capacity batteries for electric vehicles and hybrid vehicles has been promoted. Among various kinds of batteries, rechargeable lithium batteries have attracted attention due to their high energy density and high power.

Especially, rechargeable lithium-air batteries have attracted attention as a rechargeable lithium battery for electric vehicles and hybrid vehicles, which is required to have high energy density. Rechargeable lithium-air batteries use oxygen in the air as a cathode active material. Therefore, compared to conventional lithium rechargeable batteries containing a transition metal oxide (e.g., lithium cobaltate) as a cathode active material, rechargeable lithium-air batteries are able to have larger capacity.

The following reactions are known as the reactions which occur in a rechargeable lithium-air battery using a lithium metal as the anode active material, while the reactions vary depending on the used electrolyte, etc.

### Upon Discharge:

At anode: Li→Li⁺+e⁻

At air cathode: 2Li⁺+x/2O₂+2e⁻→Li₂Oₓ

### Upon Charge:

At anode: Li⁺+e⁻→Li

At air cathode: Li₂Ox→2Li⁺+x/2O₂+2e⁻

In the reaction which occurs in the air cathode upon discharge, the lithium ion (Li⁺) is dissolved from the anode by electrochemical oxidation and transferred to the air cathode through an electrolyte. The oxygen (O₂) is supplied to the air cathode.

The electrochemical reaction of the oxygen in the air cathode has a slow reaction rate and causes large overvoltage, resulting in a decrease in battery voltage on discharge and a substantially larger voltage required for recharge. Consequently, to increase the reaction rate of the electrochemical reaction of the oxygen, attempts have been made to add an electrode catalyst to the air cathode (for example, see Patent Literatures 1 to 3 and Non-Patent Literatures 1 to 12).

For example, in Non-Patent Literature 3, a cathode for rechargeable lithium-air batteries is disclosed, the cathode using α-MnO₂ as a cathode catalyst. In Non-Patent Literature 3, the cathode is produced in such a manner that synthesized catalyst particles, carbon, a binder and a solvent are mixed together to produce a slurry and the slurry is coated onto a current collector.

In Non-Patent Literature 6, carbon-supported manganese oxide material is disclosed, which is produced in such a manner that an aqueous solution of carbon powder is stirred with a magnetic stirrer at 80° C. and after a MnSO₄.H₂O aqueous solution and a KMnO₄ aqueous solution are added thereto drop-wise, the resulting solution is filtered, dried at 120° C. overnight and heat-treated at several temperatures.

### CITATION LIST

### Patent Literature

Patent Literature 1: U.S. Pat. No. 7,147,967 B1
Patent Literature 2: U.S. Pat. No. 7,807,341 B2
Patent Literature 3: International Publication No. WO2002/13292A2

### Non-Patent Literature

Non-Patent Literature 1: Rechargeable Li₂O₂ Electrode for Lithium Batteries, T. Ogasawara, A. Debart, M. Holzapfel and P. G. Bruce, J. Am. Chem. Soc., 128, 1390-1393 (2006).
Non-Patent Literature 2: An O₂ Cathode for Rechargeable Lithium Batteries, the effect of catalyst, A. Debart, J. Bao, G. Armstrong, and P. G. Bruce. J. Power Sources, 174. 1177-1182 (2007).
Non-Patent Literature 3: α-MnO₂ nanowires: a catalyst for the O₂ electrode in rechargeable Li-battery, A. Debart, A. J. Paterson, J. Bao, P. G. Bruce. Angewandte Chemie, 2008, 47, 4521-4524.
Non-Patent Literature 4: Effect of catalyst on the performance of rechargeable lithium/air batteries, A. Debart, J. Bao, G. Armstrong, P. G. Bruce. ECS Transactions, 3, 225-232 (2007).
Non-Patent Literature 5: The Li-Air battery, J. Bao, F. Bardé, S. A. Freunberger, V. Giordani, L. J. Hardwick, Z. Peng and Peter G. Bruce, Presentation at 50th battery Symposium, Kyoto, JP, November 2009.
Non-Patent Literature 6: Carbon-supported manganese oxide nanocatalyst for rechargeable lithium-air batteries, H. Cheng, K. Scott, J. Power Sources, (2009).
Non-Patent Literature 7: A polymer electrolyte-based rechargeable lithium/oxygen battery, K. M. Abraham, Z. Jiang, J. Electrochem. Soc. Vol. 143, No. 1, (1996).
Non-Patent Literature 8: Hybrid air electrode for Li-Air batteries, J. Xiao, Wu Xu, Ji-Guang Zhang et al., J. Electrochem. Soc., 157(3) A294-A297 (2010).
Non-Patent Literature 9: Lithium-air batteries using hydrophobic room temperature ionic liquid electrolyte, Kukobi. 2005, J. Power Sources, Toshiba.
Non-Patent Literature 10: The ultimate battery, Fall 2004 meeting of ECS, Authur Dobley.
Non-Patent Literature 11: Non-Aqueous Lithium-Air batteries with an advanced cathode structure, A. Dobley, J. Di Carlo, and K. M. Abraham, Yardney Technical Products Inc./Lition
Non-Patent Literature 12: Characterization of Li-O₂ organic electrolyte battery, J. Read, J. Electrochem. Soc. 149, (9), A1190-A1195, (2002).

### SUMMARY OF INVENTION

### Technical Problem

Even though conventional cathode catalysts for rechargeable metal-air batteries as disclosed in Patent Literatures 1 to 3 and Non-Patent Literatures 1 to 12 are used, there are problems such as (1) low initial capacity and (2) a large difference between discharging voltage and charging voltage and thus poor energy efficiency.

Accordingly, there is a demand for a cathode material which provides high catalyst use efficiency and sufficient catalyst performances even when the amount of catalyst is small.

The present invention was achieved in view of the above circumstances. An object of the present invention is to provide a cathode material that is able to increase the initial capacity and energy efficiency of a rechargeable lithium-air battery.

### Solution to Problem

The method for producing a cathode material of the present invention is a method for producing a cathode material for rechargeable lithium-air batteries, which has a cathode catalyst loaded onto carbon, the method comprising:

a step of sonicating a mixed solution comprising a carbon having a specific surface area of 20 to 1,500 m²/g, a surfactant and a solvent, and

a step of in situ synthesis of the cathode catalyst by (1) adding a cathode catalyst raw material to the mixed solution and (2) adding a solution containing an oxidant to the mixed solution to cause in situ precipitation of the cathode catalyst onto the carbon, the catalyst having a wire form in which the short axis length is smaller than that of the carbon and is 2 to 50 nm and the long axis length is longer than that of the carbon and is 5 to 200 nm.

The method for producing the cathode material of the present invention succeeded in improving the loading property of the cathode catalyst onto the carbon by synthesizing the cathode catalyst and loading it onto the carbon (support) at the same time. Therefore, the method is able to produce a cathode material which is able to provide sufficient catalyst performances and increase battery performances even when the amount of the used catalyst is small.

From the viewpoint of the homogeneity of the cathode catalyst distribution onto the carbon support and the intimate contact between the cathode catalyst and the carbon support, the synthesis step preferably comprises a step of adsorbing a cathode catalyst metal ion on the carbon by adding a cathode catalyst metal salt to the mixed solution, and a step of adding a cathode catalyst metal ion oxidant to the mixed solution after the adsorption step to oxidize. the cathode catalyst metal ion.

An example of the cathode catalyst is α-MnO₂.

The cathode material of the present invention is a cathode material for rechargeable lithium-air batteries, which has a cathode catalyst loaded onto carbon, wherein the cathode catalyst has a wire form in which the short axis length is smaller than that of the carbon and is 2 to 50 nm and the long axis length is longer than that of the carbon and is 5 to 200 nm; wherein the carbon has a specific surface area of 20 to 1,500 m2/g; and wherein the percentage of the weight of the cathode catalyst to the total of the weights of the carbon and cathode catalyst (“the weight of the cathode catalyst”/“the total of the weights of the carbon and cathode catalyst”) is 1% or more and 50% or less.

The cathode material of the present invention is able to provide greater catalyst performances than conventional catalysts despite that the percentage of the weight of the nanosized cathode catalyst to the total of the weights of the cathode catalyst and carbon (support) is as small as 50% or less (by weight ratio).

In the cathode material of the present invention, an example of the cathode catalyst is α-MnO₂.

When the percentage of the weight of the cathode catalyst is 38% or less, the cathode material is able to provide particularly excellent catalyst performances.

The specific surface area of the cathode material is preferably 100 m²/g or more, so that excellent rechargeable battery properties are obtained.

The specific surface area of the cathode catalyst is preferably 250 m²/g or more, so that excellent rechargeable battery properties are obtained.

The rechargeable lithium-air battery of the present invention is a rechargeable lithium-air battery comprising an anode, an air cathode and an electrolyte that is present therebetween, wherein the air cathode comprises a cathode material produced by the production method of the present invention or the cathode material of the present invention.

### Advantageous Effects of Invention

According to the present invention, it is able to increase the initial capacity and energy efficiency of a rechargeable lithium-air battery.

### BRIEF DESCRIPTION OF DRAWINGS

FIG. 1 is a view showing a structural example of the rechargeable lithium-air battery of the present invention.

FIG. 2 shows X-ray diffraction patterns of Examples 1 to 4.

FIG. 3 shows X-ray diffraction reflections resulting from Selected Area Fourier Transformation of HRTEM (High Resolution-Transmission Electron Microscopy) images of Example 3.

FIG. 4 shows HRTEM pictures and Selected Area Fourier Transformation electron diffractograms of Example 3.

FIG. 5 shows charging/discharging voltage versus capacity (mAh/g-carbon) of Examples 1, 3 and 4 during cycle 1.

FIG. 6 shows charging/discharging voltage versus capacity (mAh/g-electrode) of Examples 1, 3 and 4 during cycle 1.

FIG. 7 shows charging/discharging voltage versus capacity of Example 1 during several cycles.

FIG. 8 shows charging/discharging voltage versus capacity of Example 3 during several cycles.

FIG. 9 shows charging/discharging voltage versus capacity of Example 4 during several cycles.

FIG. 10 shows charging/discharging voltage versus capacity of Comparative Example 1 and Example 3.

FIG. 11 shows overvoltage of Comparative Example 1 and Example 3.

FIG. 12 shows capacity (mAh/g-electrode) of Comparative Example 1 and Example 3.

FIG. 13 shows the comparison between prior art and the processes to prepare an air cathode of the present invention.

### DESCRIPTION OF EMBODIMENTS

The method for producing a cathode material of the present invention is a method for producing a cathode material for rechargeable lithium-air batteries, which has a cathode catalyst loaded onto carbon, the method comprising:

a step of sonicating a mixed solution comprising a carbon having a specific surface area of 20 to 1,500 m²/g, a surfactant and a solvent, and

a step of in situ synthesis of the cathode catalyst by (1) adding a cathode catalyst raw material to the mixed solution and (2) adding a solution containing an oxidant to the mixed solution to cause in situ precipitation of the cathode catalyst onto the carbon, the catalyst having a wire form in which the short axis length is smaller than that of the carbon and is 2 to 50 nm and the long axis length is longer than that of the carbon and is 5 to 200 nm.

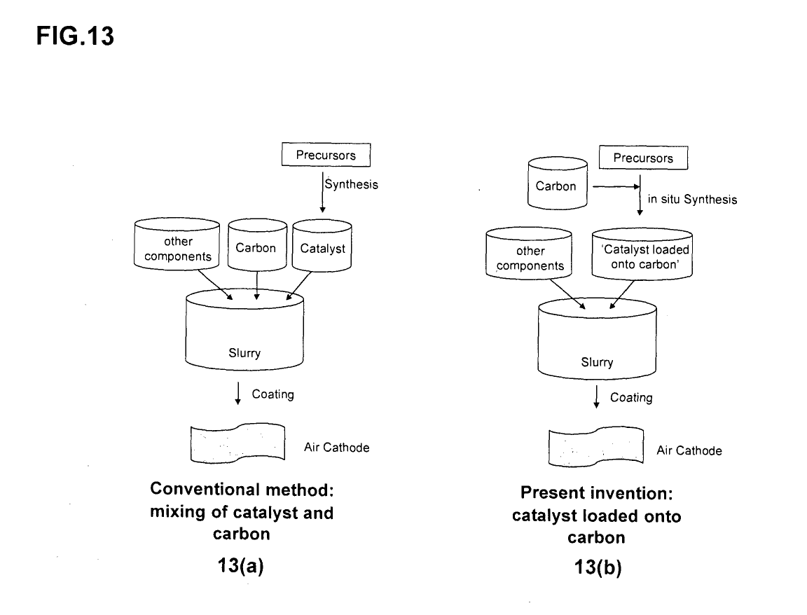

As shown in FIG. 13, conventionally, the air cathode comprising a cathode catalyst of a rechargeable lithium-air battery is normally produced with a mixed cathode material produced by the mechanical mixing of a cathode catalyst, carbon and other component(s) as needed, such as a binder. In this cathode production method, the cathode catalyst is likely to aggregate, so that it is very difficult to highly disperse the cathode catalyst. As a result, to ensure catalyst performances, the quantity of the cathode catalyst used in the cathode has to be large. In general, the cathode catalyst is non-conductive or has very low conductivity, so that when the quantity of the cathode catalyst is large, there are problems such as an increase in electrode resistance in the cathode and a decrease in capacity since the quantity of the carbon which acts as an electrode reaction site is relatively small. A nanosized cathode catalyst has a high-specific surface area and is very likely to aggregate, so that the above problems occur frequently. Also, there is poor contact between the carbon (catalyst support) and the cathode catalyst; therefore, there is a problem of low cathode catalyst utilization.

The inventors of the present invention found out that a cathode material is obtained by synthesizing the cathode catalyst in the presence of carbon and a surfactant, instead of the mechanical mixing of a cathode catalyst and a conductive material (carbon) employed in conventional air cathode production methods, the cathode material being such that a nanosized cathode catalyst having a short axis length of 2 to 50 nm and a long axis length of 5 to 200 nm is directly precipitated onto the carbon surface and the cathode catalyst chemically binds to the carbon. Furthermore, the inventors found out that the cathode material has excellent electrochemical performances and is thus able to solve the above problems.

More specifically, in the present invention, the cathode catalyst is synthesized in the mixed solution comprising carbon and a surfactant, the solution being previously sonicated.

The production method of the present invention uses a carbon having a specific surface area of 20 to 1,500 m²/g as a conductive material. The carbon having such a large surface area has many reaction sites that are available for adsorption or chemical reactions; therefore, it provides many reaction sites during the precipitation of the cathode catalyst and effectively promotes the precipitation reaction of the fine cathode catalyst as described above. In addition, the carbon effectively functions also in the electrode reaction at the air cathode. Also, the carbon having such a large surface area has good wettability with electrolyte. Therefore, the cathode material comprising the carbon has high affinity for electrolyte and is able to form an air electrode having excellent contact properties with the cathode catalyst and electrolyte.

Also, by synthesizing the cathode catalyst in the presence of a surfactant, the production method of the present invention is able to induce the formation of small crystals of the cathode catalyst and to avoid the formation of a cathode catalyst having a large particle diameter.

In addition, by initially sonicating the mixed solution comprising carbon and a surfactant, the production method of the present invention is able to destroy the aggregates formed by carbon particles and to obtain a very good dispersion of carbon particles into the solution, wetting of the surface of carbon with the surfactant solution. As a result, more surface of carbon is available for absorption of catalyst precursors (e.g., cathode catalyst metal salts) in the next step of the production method.

In the cathode material obtained by the production method of the present invention, the cathode catalyst is synthesized in situ on the surface of the carbon, so that all the cathode catalyst particles are in intimate contact with the carbon by chemical binding. Also in the cathode material, the cathode catalyst has such a nanosize as described above and is loaded onto the carbon in a finely dispersed state. Therefore, the present invention is able to produce a cathode material which provides sufficient catalyst performances, while using a small amount of catalyst. In particular, to obtain sufficient catalyst performances, conventional air cathodes produced by the mechanical mixing are required to have a percentage of the weight of the cathode catalyst to the total of the weights of the carbon and cathode catalyst (“the weight of the cathode catalyst”/“the total of the weights of the cathode catalyst and carbon”) of more than 60%. However, when the cathode material provided by the present invention is used, it is able to make the percentage of the weight of the cathode catalyst to the total weight 50% or less.

By forming an air cathode with the above-described cathode material of the present invention, first, it is possible to increase the capacity of a rechargeable lithium-air battery. It is possible to remarkably increase not only the capacity with respect to the weight of the carbon in the air cathode, but also the capacity with respect to the weight of the entire air cathode by the effect of increasing the utilization of the cathode catalyst and therefore reducing the necessary amount of the catalyst. In addition, by forming the air cathode with the cathode material of the present invention, it is possible to increase the discharging voltage of a rechargeable lithium-air battery and to decrease the charging voltage of the same. The increase in discharging voltage and the decrease in charging voltage have been one of the most difficult issues for rechargeable lithium-air batteries to be solved, and there is little report on solutions to the increase in discharging voltage. It is not yet clear why the above-described high energy efficiency is obtained by the cathode material of the present invention; however, the reason is assumed as follows: the reason why there is an increase in the energy efficiency of a rechargeable lithium-air battery formed with the cathode material of the present invention although the surface of the carbon (conductive material) in the cathode material is covered with the cathode catalyst having low conductivity or being non-conductive, is assumed to be that the cathode catalyst has the above-described nanosize and is in good contact with the carbon, so that a cathode reaction proceeds on not only the carbon surface but also the cathode catalyst surface by the tunnel effect.

In the present invention, the method for measuring the length of the short and long axes of the cathode catalyst and those of the carbon is not particularly limited. For example, they can be measured by TEM, etc.

The specific surface area of the carbon can be measured by the BET (Brunauer Emmett and Teller) method or by the BJH (Barrett Joyner Halenda) method, for example.

Hereinafter, the method for producing the cathode material of the present invention, the cathode material of the present invention, and the rechargeable lithium-air battery of the present invention will be described in detail.

First, the steps of the method for producing the cathode material will be described below.

### (Sonication Step)

The sonication step is a step of sonicating a mixed solution comprising a carbon having the specific surface area specified above, a surfactant and a solvent.

The carbon used in the present invention is not particularly limited as long as it is a porous material in the form of a powder and has a high specific surface area of 20 to 1,500 m²/g. For example, there may be used a carbon on which, prior to the sonication step, a treatment is performed by a general method to increase porosity or surface area, followed by another treatment to increase the wettability. Examples of the commercial carbon products which can be used in the present invention include the KS series, SFG series, Super P series and Super S series available from TIMCAL Ltd., activated carbon products available from Norit, Black Pearl and AB-Vulcan 72 available from Cabot, and KB-ECP and KB-ECP600JD available from KB International. Other examples of commercially available carbon include the WAC powder series available from Xiamen All Carbon Corporation, PW15-type, J-type and S-type Activated Carbons available from Kureha, and Maxsorb MSP-15 available from Kansai Netsu Kagaku.

Examples of the method for increasing the porosity, surface area and wettability of the carbon include physical activation or chemical activation. The chemical activation method includes, for example, immersing the carbon material in a strong alkaline aqueous solution (potassium hydroxide solution for example), in an acid solution (nitric acid or phosphoric acid for example) or in a salt (zinc chloride for example). This treatment can be followed (but not necessarily) by a calcination step at relatively low temperature (450° C. to 900° C. for example).

In the present invention, it is possible to use, for example, carbon black treated/activated by stirring it in concentrate HNO₃ for 3 days at room temperature. During the treatment/activation, the amount of acid versus carbon depends on the nature of the carbon and is preferably chosen to yield a slurry which is liquid enough to be stirred by means of a magnetic stirrer, etc. HNO₃ is preferable because it has an oxidizing effect on the carbon surface which affords polar groups on the surface that improves wettability. The carbon is then filtrated and washed with deionized water until a neutral pH of the solution is obtained. In this case, it is not necessary to apply a post calcination step.

From the viewpoint of active electrochemical surface area, the carbon preferably has a specific surface area of 20 to 500 m²/g, more preferably 60 m²/g. In addition, the carbon preferably has pores having a pore diameter of 20 nm or more. The specific surface area of the carbon and the pores size can be measured by the BET method or the BJH method, for example. Furthermore, in general, the carbon preferably has an average particle diameter (primary particle diameter) of 8 to 350 nm, more preferably 30 to 50 nm. The average primary particle diameter of the carbon can be measured by TEM.

For the carbon, it is possible to use aggregates formed from aggregated primary particles. The properties of carbon black (such as hardness, electrical conductivity, dispersability and viscosity) can be increased by the higher structure or shape of the aggregates. The surface activity and chemical properties of carbon can be evaluated or quantified from the chemical and physical properties of carbon (such as abrasion resistance, tensile strength, oil absorption number and hysteresis).

The surfactant is not particularly limited as long as it is able to form a micelle around the carbon. A too high amount of the surfactant in the solution will lead to the formation of micelle in the solution which would lead to the formation of catalyst next to the carbon and not onto the carbon. A too low amount of the surfactant in the solution would lead to imperfect micelle around the carbon which will results in a non-optimized adsorption of the cathode catalyst precursor (cathode catalyst metal salt, for example) onto the carbon. Generally, it is preferable that approximately 0.8 g of surfactant is dissolved in 10 mL solvent. Examples of the surfactant include amphiphilic surface active agents such as anionic, cationic and polar uncharged compounds. Examples are polyoxyethylene-p-isooctylphenol, poly(ethylene glycol)-block-poly(propylene glycol)-block-poly(ethylene glycol). Suitable commercially available surfactants include Pluronic 123 and Triton X, for example.

The solvent is not particularly limited as long as it dissolves the surfactant and cathode catalyst raw material (for example, cathode catalyst precursors such as cathode catalyst metal salts). Examples of the solvent include alcohols such as ethanol and isopropanol, and water. In particular, there may be mentioned a combination of an organic solvent that is able to dissolve the surfactant, such as alcohol, and an aqueous solvent that is able to dissolve the cathode catalyst raw material.

In the mixed solution, the ratio of the carbon to the surfactant is not particularly limited. For example, it is preferably 1:4 to 3:4 (carbon:surfactant by weight ratio). When the weight ratio is in the above range, it is able to disperse the carbon aggregates and to ensure a good wetting of the carbon surface.

In the mixed solution, the amount of the solvent is not particularly limited and can be appropriately determined depending on the surfactant, carbon and solvent used. For example, in the case of using Pluronic 123 (surfactant), Super P (carbon) and a mixed solution of water and ethanol (solvent), in the mixed solution of 1 mL, 0.08 g surfactant and 0.02 g to 0.06 g carbon can be mixed.

In the sonication step, the sonication time of the mixed solution is not particularly limited. Normally, it is preferably 15 minutes to 60 minutes, particularly preferably 15 minutes. By sonicating the solution for 15 minutes to 60 minutes, it is able to effectively form micelle of the surfactant around the carbon particles.

### (Catalyst Synthesis Step)

The catalyst synthesis step is a step of in situ synthesis of the cathode catalyst by (1) adding a cathode catalyst raw material to the mixed solution subjected to the sonication step and then (2) adding a solution containing an oxidant to the mixed solution to cause in situ precipitation of the cathode catalyst onto the carbon, the catalyst having the above-specified form and size.

In the synthesis step, typically, a cathode catalyst metal compound containing a cathode catalyst metal species that will form the cathode catalyst (that is, the cathode catalyst raw material) is added to the mixed solution and dissolved. Then, an oxidant solution is added thereto to precipitate a dissociated cathode catalyst metal ion as the catalyst metal species (catalyst metal oxide species). At this time, the carbon is contained in the mixed solution, so that as the synthesis of the cathode catalyst (catalyst metal, catalyst oxide metal) proceeds on the surface of the carbon, the cathode catalyst can be directly loaded onto the carbon surface.

The cathode catalyst raw material can be appropriately selected depending on the cathode catalyst to be synthesized.

The cathode catalyst is not particularly limited as long as it shows catalyst activities for cathode reaction in a rechargeable lithium-air battery. Examples of the cathode catalyst include metal oxides such as MnO₂, NiFe₂O₄, Fe₂O₃, Co₃O₄, LiCoO₂, CeO₂, PbO₂, CuO and NiO. Of those, preferred is MnO₂ and particularly preferred is α-MnO₂.

Raw materials for the cathode catalyst metal oxide described above as an example of the cathode catalyst include, for example, a cathode catalyst metal compound which contains a metal species that will form the cathode catalyst metal oxide and an oxidant that oxidizes a cathode catalyst metal ion derived from the cathode catalyst metal compound. Examples of the cathode catalyst metal compound include metal salts (cathode catalyst metal salts) such as a chloride, a nitrate salt, a sulfate salt and metal complexes. Examples of the oxidant include KMnO₄, H₂O₂, O₃, ClO₂, Cl₂, ammonium permanganate, or sodium permanganate. KMnO₄ is preferred since it promotes the formation of α-MnO₂. H₂O₂ and sodium permanganate promote the β-MnO₂ formation. From the viewpoint of miscibility (mixing uniformity) with the mixed solution, the metal compound and oxidant are preferably added to the mixed solution in the form of solution.

The added quantity of the cathode catalyst metal salt can be appropriately determined depending on the ratio of the carbon to cathode catalyst in the cathode material to be produced. As described above, according to the production method of the present invention, a cathode material that provides sufficient catalyst performances can be obtained even when the percentage of the weight of the cathode catalyst contained in the cathode material, more specifically, the value obtained from [“the weight of the cathode catalyst”/“the total of the weights of the cathode catalyst and carbon”×100%] is 50% or less. Accordingly, typically, it is preferable to add the cathode catalyst raw material to the mixed solution so that in the cathode material to be obtained, the weight of the cathode catalyst is 50% or less relative to the total of the weight of the carbon and that of the cathode catalyst to be synthesized. To obtain sufficient catalyst performances, in the cathode material thus obtained, the percentage of the weight of the cathode catalyst (“the weight of the cathode catalyst”/“the total of the weights of the cathode catalyst and carbon”×100%) is 1% or more. From the viewpoint of the initial capacity, energy efficiency (especially discharging and charging voltage) and cycle characteristics of the rechargeable lithium-air battery produced with the cathode material of the present invention, the percentage of the weight of the cathode catalyst is preferably 43% or less (particularly preferably 38% or less) and 5% or more in the cathode material of the present invention.

The synthesis step preferably comprises an adsorption step of adsorbing a dissolved cathode catalyst metal ion on the carbon by adding a cathode catalyst metal salt to the mixed solution, and an oxidant addition step of adding a cathode catalyst metal ion oxidant to the mixed solution after the adsorption step to oxidize and precipitate the cathode catalyst metal ion.

This is because the cathode catalyst metal ion is able to adsorb on the surface of the carbon so that a good homogeneity of catalyst dispersion onto the carbon is finally achieved. In addition, thanks to this previous adsorption step, the final contact between the carbon and cathode catalyst is expected to be intimate. This facilitates the formation of three phase interface (triple point) in the cathode where O₂, conducting metal ion (for example, Li⁺) and e⁻ react easily.

In the adsorption step, the method for adsorbing the cathode catalyst metal ion on the carbon is not particularly limited. An example of the method is a method for sufficiently stirring the mixed solution containing the cathode catalyst metal salt before the addition of the oxidant. The method for stirring is not particularly limited and examples of the method include magnetic stirring and mixing with help of a rotation/revolution mixer such as Thinky mixer. The temperature employed in the adsorption step is not particularly limited and can be room temperature (approximately 15 to 30° C.), for example. The time for stirring can be appropriately determined. However, to adsorb the metal ion sufficiently on the carbon surface, the time is preferably about 1 to 72 hours. The metal salt is preferably added to the mixed solution in the form of solution.

In the oxidant addition step, it is preferable to add the oxidant in the form of solution to the mixed solution after the adsorption step and to stir the resultant sufficiently. The time for stirring in the oxidant addition step can be appropriately determined and is, for example, preferably about 1 to 24 hours.

In the present invention, the cathode catalyst loaded onto the carbon is in the above-described wire form, thereby having excellent electrocatalytic activity. The wire form refers to a form in which one dimension of the crystal is typically significantly larger than the others. In particular, it has a longer long axis length than that of, the carbon support and a shorter short axis length than that of the same.

The method for synthesizing the cathode catalyst in a wire form on the carbon is not particularly limited and a general method for forming a metal compound crystal in a wire form can be employed. An example of a method for synthesizing a-MnO₂ in a wire form is as follows.

A solution of KMnO₄ is added to a solution of MnSO₄. As the KMnO₄ solution, there may be mentioned a solution prepared by adding 0.4967 g of KMnO₄ to 20 mL of distillated water and stirring the mixture for at least 30 minutes in a glass vessel. As the MnSO₄ solution, there may be mentioned a solution prepared by adding 0.2125 g of MnSO₄ to 20 mL of distillated water and stirring the mixture for at least 30 minutes in a glass vessel.

The resulting brownish solution is stirred for at least hour at room temperature (approximately 25° C.). This solution is then transferred in a Teflon vessel of an autoclave cell. The volume of the solution shall not exceed ⅔ of the volume of the Teflon vessel.

The autoclave cell is sealed and transferred into an oven. Then, it is heated for one hour from room temperature (25° C.) to 150° C., followed by heating for 24 hours at 150° C. and then cooling down from 150° C. till room temperature (25° C.) After cooling, the solution is recuperated, filtrated and rinsed first with distillated water and then with ethanol. Finally, the resulting powder is dried at 80° C. under vacuum for 12 hours at least.

### (Other Step)

After the synthesis step, the thus-obtained cathode material is preferably appropriately washed with an appropriate solvent as needed. In addition, after the washing, the cathode material is dried appropriately at about 80 to 200° C. No heat treatment is especially needed, such as calcination.

A cathode material is obtained according to the present invention, which has a cathode catalyst loaded onto carbon, wherein the cathode catalyst has a wire form in which the short axis length is smaller than that of the carbon and is 2 to 50 nm and the long axis length is longer than that of the carbon and is 5 to 200 nm; wherein the carbon has a specific surface area of 20 to 1,500 m2/g; and wherein the percentage of the weight of the cathode catalyst to the total of the weights of the carbon and cathode catalyst (“the weight of the cathode catalyst”/“the total of the weights of the carbon and cathode catalyst”) is 1% or more and 50% or less.

In the above-described cathode material of the present invention, the nanosized cathode catalyst is loaded onto the carbon surface having a large specific area, high porosity and excellent wettability, so that it provides excellent catalyst performances even though the weight (loaded catalyst amount) of the cathode catalyst to the total weight of the carbon and cathode catalyst is a relatively small amount of 1 to 50%.

In the cathode material of the present invention, the short axis length of the cathode catalyst is 2 to 50 nm, preferably 2 to 30 nm, more preferably 2 to 10 nm, while the long axis length is 5 to 200 nm, preferably 10 to 200 nm, more preferably 10 to 100 nm.

The cathode material of the present invention preferably has a specific surface area of 100 m²/g or more, particularly preferably 140 m²/g or more, so that the cathode material shows excellent energy efficiency and initial capacity. The specific surface area of the cathode material can be measured by the BET method, etc.

Also in the cathode material of the present invention, the cathode catalyst preferably has a specific surface area of 250 m²/g or more, particularly preferably 270 m²/g, so that the cathode material shows excellent energy efficiency and initial capacity. The specific surface area of the cathode catalyst can be measured by the BET method, etc.

Hereinafter, an example of the method for measuring (calculating) the specific surface area of the cathode catalyst will be described in detail. In the following example, a case of using MnO₂ as the cathode catalyst will be described; however, the method described below can be used regardless of the type of the cathode catalyst.

The BET surface area of the MnO₂ can be calculated from the total BET (BETₜₒₜ) via:

BETₜₒₜ=BET_{C}*(1−f_{MnO2})+BET_{MnO2}*f_{MnO2}

where f_{MnO2} is the weight fraction of MnO₂ in the cathode material (complex of the cathode catalyst and carbon). With the BET surface area of the carbon (BET_{c}) being 62 m²/g, the BET surface area of the deposited MnO₂ (BET_{MnO2}) can be calculated from the formula:

BET_{MnO2}=(BETₜₒₜ−62*(1−f_{MnO2}))/f_{MnO2}

The type of the cathode catalyst, the type of the carbon, the specific surface area of the carbon, the preferable range of the weight ratio (“the weight of the cathode catalyst”/“the total of the weights of the cathode catalyst and carbon”) and so on will not be described here since they are the same as those described above in connection with the method for producing the cathode material of the present invention.

In the case of using the cathode material of the present invention which contains the carbon and the cathode catalyst at the above ratio, it is able to produce an air cathode for rechargeable lithium-air batteries without adding a conductive material separately, such as carbon.

The cathode material of the present invention can be used as a material for forming the air cathode of a rechargeable lithium-air battery.

In particular, the rechargeable lithium-air battery of the present invention is a rechargeable lithium-air battery comprising an anode, an air cathode and an electrolyte that is present therebetween, wherein the air cathode comprises a cathode material produced by the method of the present invention or the cathode material of the present invention.

As described above, the air cathode of the rechargeable lithium-air battery of the present invention is composed of the cathode material of the present invention which is able to increase the initial capacity and energy efficiency of the rechargeable lithium-air battery. Because of this, the rechargeable lithium-air battery of the present invention has excellent electrochemical properties such as initial capacity properties and energy efficiency.

Hereinafter, an example of the structure of the rechargeable lithium-air battery of the present invention will be described. The rechargeable lithium-air battery of the present invention is not limited to the following structure.

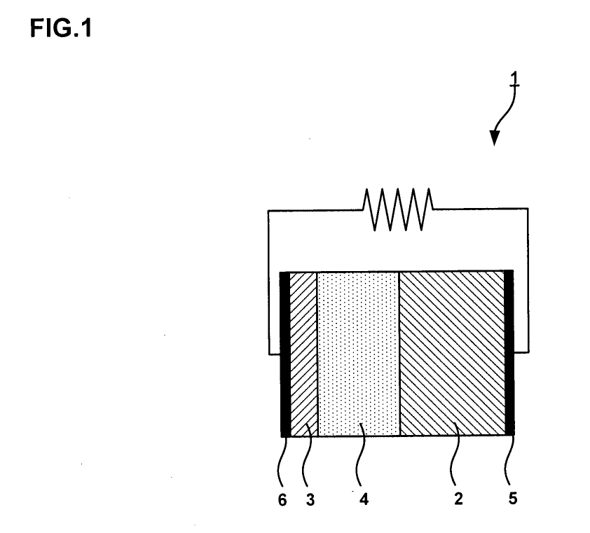

FIG. 1 shows a cross section of an embodiment of the rechargeable lithium-air battery of the present invention. Rechargeable lithium-air battery 1 comprises anode 2 which contains an anode active material, air cathode 3 which uses oxygen as an active material, electrolyte 4 which is present between anode 2 and air cathode 3 and conducts ions from the anode to the air cathode and vice versa, anode collector 5 which corrects current from anode 2, and air cathode collector which collects current from air cathode 3. Rechargeable lithium-air battery 1 further comprises a battery case (not shown) which houses the above components.

Anode collector 5 is electrically connected to anode 2, which collects current from anode 2. Air cathode collector 6 is electrically connected to air cathode 3, which collects current from air cathode 3. Air cathode collector 6 has a porous structure which is able to supply oxygen to air cathode 3. One end of anode collector 5 and that of air cathode collector 6 protrude from the battery case and act as an anode terminal (not shown) and cathode terminal (not shown), respectively.

### (Air Cathode)

The air cathode comprises the cathode material of the present invention. As described above, it is not necessarily needed to add a conductive material in addition to the carbon that comprises the cathode material. As needed, the air cathode can comprise a binder, etc.

The cathode material of the present invention was described above and thus will not be described here. The content of the cathode material in the air cathode is not particularly limited. For example, the content is preferably to 50 wt %, more. preferably 99 to 70 wt %, still more preferably 99 to 85 wt %.

When a binder is contained in the air cathode, the formability of the cathode material can be increased. The binder is not particularly limited and examples thereof include polyvinylidene fluoride (PVDF) and copolymers thereof, polytetrafluoroethylene (PTFE) and copolymers thereof, and styrene-butadiene rubber (SBR).

The content of the binder in the air cathode is not particularly limited. For example, the content is preferably to 50 wt %, more preferably 1 to 30 wt %, still more preferably 1 to 15 wt %.

For example, the air cathode is formed by applying a slurry to a substrate and drying it, which was prepared by dispersing the cathode material and other component(s) (if necessary) in an appropriate solvent. The solvent is not particularly limited and examples thereof include acetone, N,N-dimethylformamide, N-methyl-2-pyrrolidone (NMP), and propylene carbonate (PC).

The substrate to which the slurry is applied is not particularly limited and examples thereof include a glass plate and a Teflon plate. The substrate is removed from the thus-obtained air cathode after the drying of the slurry. Or, a collector or solid electrolyte layer of the air cathode can be used as the substrate. In this case, the substrate does not have to be removed and can be used as it is as a component of the rechargeable lithium-air battery.

The method for applying the slurry and the method for drying the same are not particularly limited and general methods can be employed. For example, there may be used an applying method such as a spraying method, a doctor blade method and gravure printing method, and a drying method such as drying by heating and drying under reduced pressure.

The thickness of the air cathode is not particularly limited and can be appropriately determined depending on the intended use of the rechargeable lithium-air battery, etc. It is normally 5 to 100 μm, preferably 10 to 50 μm.

In general, an air cathode collector is connected to the air cathode, which collects current from the air cathode. The material for the air cathode collector and the shape of the same are not particularly limited. Examples of the material for the air cathode collector include stainless steel, aluminum, iron, nickel, titanium and carbon. Examples of the form of the air cathode collector include a foil form, a plate form, a mesh (grid) form and a fibrous form. Preferably, the air cathode collector has a porous structure such as a mesh form since the collector having a porous structure has excellent efficiency of oxygen supply to the air cathode.

### (Anode)

The anode comprises at least an anode active material. As the anode active material, general anode active materials for lithium batteries can be used and the anode active material is not particularly limited. In general, the anode active material is able to store/release a lithium ion (Li⁺). Specific anode active materials are, for example, metals such as Li, Na, K, Mg, Ca, Zn, Al and Fe, alloys, oxides and nitrides of the metals, and carbonaceous materials.

Specific anode active materials for rechargeable lithium-air batteries are, for example, a lithium metal, lithium alloys such as a lithium-aluminum alloy, a lithium-tin alloy, a lithium-lead alloy and a lithium-silicon alloy, metal oxides such as a tin oxide, a silicon oxide, a lithium-titanium oxide, a niobium oxide and a tungsten oxide, metal sulfides such as a tin sulfide and titanium sulfide, metal nitrides such as a lithium-cobalt nitride, a lithium-iron nitride and a lithium-manganese nitride, and carbonaceous materials such as graphite. Of these, a lithium metal is preferred.

When a metal, alloy or the like in the form of foil or metal is used as the anode active material, it can be used as the anode itself.

The anode is required to contain at least an anode active material; however, as needed, it can contain a binder for fixing the anode active material. The type and usage of the binder are the same as those of the air cathode described above, so that they will not be described here.

In general, an anode collector is connected to the anode, which collects current from the anode. The material for the anode collector and the shape of the same are not particularly limited. Examples of the material for the anode collector include stainless steel, copper and nickel. Examples of the form of the anode collector include a foil form, a plate form and a mesh (grid) form.

### (Electrolyte)

The electrolyte is present between the air cathode and the anode. Lithium ions are conducted between the anode and the cathode through the electrolyte. The form of the electrolyte is not particularly limited and examples thereof include a liquid electrolyte, a gelled electrolyte and a solid electrolyte.

An example of the liquid electrolyte having lithium ion conductivity is a nonaqueous electrolytic solution comprising a lithium salt and a nonaqueous solvent.

Examples of the lithium salt include inorganic lithium salts such as LiPF₆, LiBF₄, LiClO₄ and LiAsF₆, and organic lithium salts such as LiCF₃SO₃, LiN(CF₃SO₂)₂, LiN(C₂F₅SO₂)₂ and LiC(CF₃SO₂)₃.

Examples of the nonaqueous solvent include ethylene carbonate (EC), propylene carbonate (PC), dimethyl carbonate (DMC), diethyl carbonate (DEC), ethyl methyl carbonate (EMC), buthylene carbonate, γ-butyrolactone, sulfolane, acetonitrile, 1,2-dimethoxymethane, 1,3-dimethoxypropane, diethyl ether, tetrahydrofuran, 2-methyltetrahydrofuran, tri ethylene glycol dimethyl ether (TEDGE), N-methyl-N-propyl piperidinium bis (trifluoromethane sulfonyl)imide (PP13TFSI) and mixtures thereof.

The concentration of the lithium salt in the nonaqueous electrolytic solution is not particularly limited. For example, it is preferably in the range of 0.1 mol/L to 3 mol/L, more preferably 1 mol/L. In the present invention, as the nonaqueous electrolytic solution, a low-volatile liquid such as an ionic liquid (for example, TEDGE or PP13TFSI) can be used.

The gelled electrolyte having lithium ion conductivity can be obtained by, for example, adding a polymer to the nonaqueous electrolytic solution for gelation. In particular, gelation can be caused by adding a polymer such as polyethylene oxide (PEO), polyvinylidene fluoride (PVDF, commercially available as Kynar, etc.), polyacrylonitrile (PAN) and polymethyl methacrylate (PMMA).

The solid electrolyte having lithium ion conductivity is not particularly limited. As the solid electrolyte, general solid electrolytes that are usable in rechargeable lithium-air batteries can be used. Examples thereof include solid oxide electrolytes such as Li_{1.5}Al_{0.5}Ge_{1.5}(PO₄)₃ and solid sulfide electrolytes, such as a Li₂S—P₂S₅ compound, a Li₂S—SiS₂ compound and a Li₂S—GeS₂ compound.

Of these electrolytes, a nonaqueous electrolytic solution is preferred.

The thickness of the electrolyte varies depending on the structure of the battery. For example, it is preferably in the range of 10 μm to 5,000 μm.

### (Other Components)

In the rechargeable lithium-air battery of the present invention, a separator is preferably provided between the air cathode and the anode for complete electrical insulation between these electrodes. The separator is not particularly limited as long as it is able to electrically insulate the air cathode and the anode from each other and has a structure that allows the electrolyte to be present between the air cathode and the anode.

Examples of the separator include porous films and nonwoven fabrics comprising polyethylene, polypropylene, cellulose, polyvinylidene fluoride, glass ceramics, etc. Of these, a separator of glass ceramics is preferred.

As the battery case for housing the rechargeable lithium-air battery, general battery cases for rechargeable lithium-air batteries can be used. The shape of the battery case is not particularly limited as long as it can hold the above-mentioned air cathode, anode and electrolyte. Specific examples of the shape of the battery case include a coin shape, a flat plate shape, a cylindrical shape and a laminate shape.

The rechargeable lithium-air battery of the invention can discharge when an active material, which is oxygen, is supplied to the air cathode. Examples of oxygen supply source include the air and oxygen gas, and preferred is oxygen gas. The pressure of the supplied air or oxygen gas is not particularly limited and can be appropriately determined.

### EXAMPLES

### Examples 1-4

### (Production of Cathode Material)

First, a surfactant (Pluronic 123) of 0.8 g was dissolved in ethanol of 10 ml. Then, previously activated carbon (product name: Super P Li, manufactured by: TIMCAL Ltd., specific surface area: 62 m²/g, average primary particle diameter: 40 nm) of 0.05 g was added to the solution, and then the solution was stirred and sonicated for two hours.

Next, 0.4 M MnSO₄ solution was added thereto and the mixture was stirred at room temperature for three days. Then, 0.25 M KMnO₄ solution (1.25 mol KMnO₄ per mol MnSO₄) was added drop-wise to the mixture and stirred for one day. The product was washed twice with ethanol, twice with water and finally with ethanol and dried at 80° C. under vacuum.

The amount of the starting carbon and Mn raw material were chosen so that the percentage of the weight of MnO₂ in the cathode material (MnO₂+carbon) is a desired value (Example 1: MnO₂/cathode material=25 wt %, Example 2: MnO₂/cathode material=30 wt %, Example 3: MnO₂/cathode material=37.6 wt %, Example 4: MnO₂/cathode material=47.5 wt %).

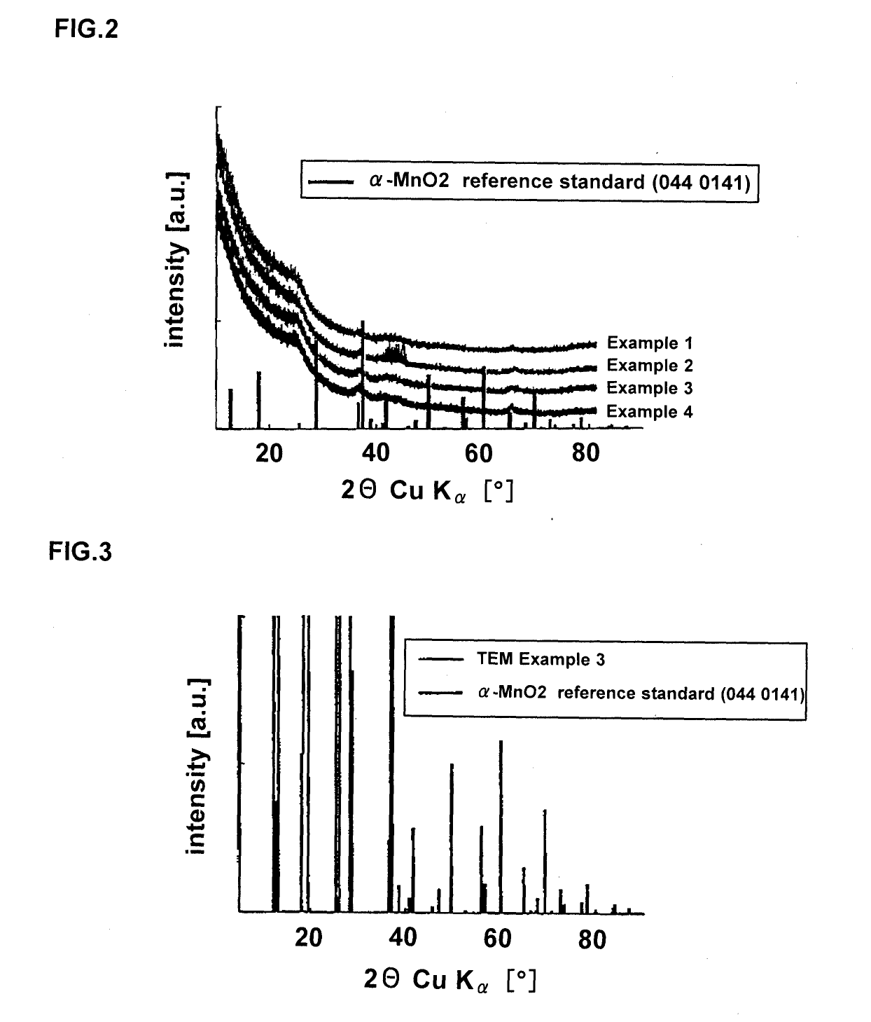

X-ray diffraction analysis of the cathode materials obtained in Examples 1 to 4 was conducted. FIG. 2 shows X-ray diffraction patterns of Examples 1 to 4 and that of α-MnO₂ (reference standard: JCPDS 044 0141). FIG. 3 shows XRD reflections obtained by Selected Area Fourier Transformation of High Resolution-Transmission Electron Microscope of Example 3.

The cathode materials obtained in Examples 1 to 4 were found to contain α-MnO₂ and carbon. Also, the cathode materials of Examples 1 to 4 were found to be amorphous. Identification of α-MnO₂ was conducted by using the XRD reflections obtained from Selected Area Fourier Transformation and High Resolution-Transmission Electron Microscope analysis.

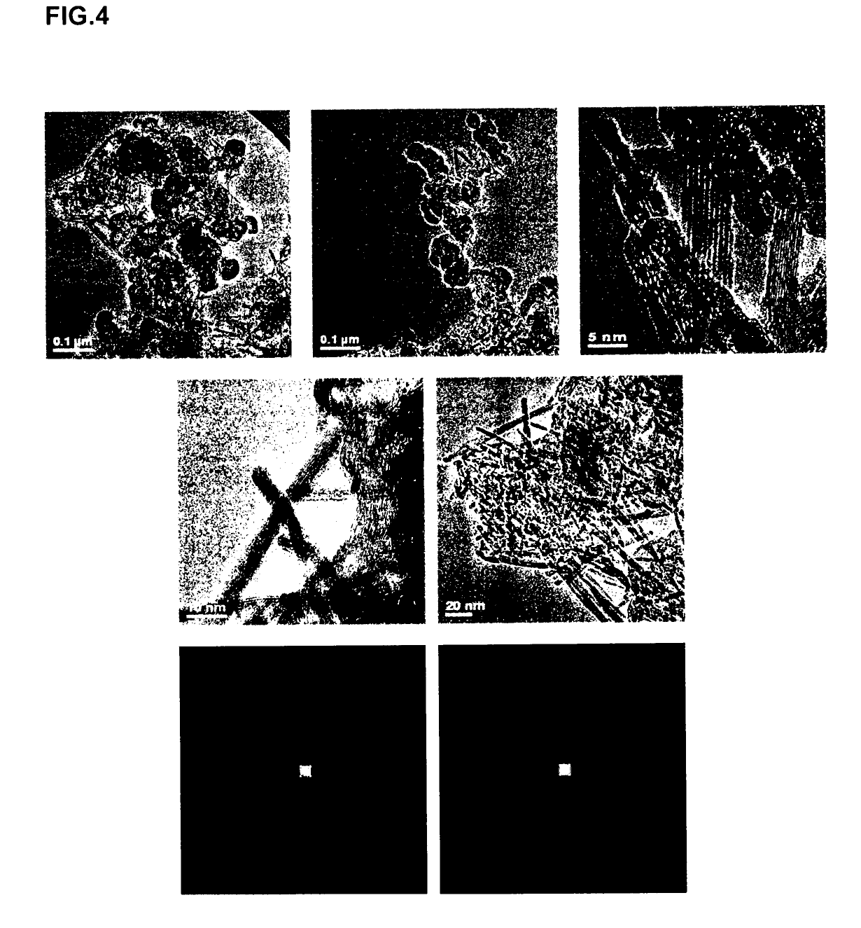

Also, the cathode material of Example 3 was observed by High Resolution Transmission Electron Microscopy (HRTEM). FIG. 4 shows HRTEM pictures and Selected Area Fourier Transformation electron diffractograms. It was found that in the cathode material of Example 3, as shown in FIG. 4, long MnO₂ wires having a long axis length of about 5 to 200 nm and a short axis length of about 2 to 50 nm (diameter) are loaded in a finely dispersed state to cover the surface of the carbon.

The specific surface area (SSA) of the cathode materials of Examples 1 to 4 were measured by the BET method. As a result, the cathode materials were found to have a high specific surface area of more than 100 m²/g. Table 1 shows the specific surface area of the cathode materials of Examples 1, 3 and 4.

### (Evaluation of Electrochemical Performance of Cathode Material)

Rechargeable lithium-air batteries were produced with the cathode materials of Example 1, 3 and 4 in the following manner. Each cathode material was mixed with a binder (a copolymer based on PVDF, product name: Kynar, manufactured by: Arkema Inc.) and a solvent (propylene carbonate) at a weight ratio of 30% (cathode material):15% (binder):55% (solvent). A slurry was produced by adding an appropriate amount of acetone to the mixture.

The slurry was applied on a glass substrate and then the acetone was evaporated to form an air cathode film.

Next, in a globe box under inert (argon) atmosphere, a rechargeable lithium-air battery was produced with the air cathode film. In particular, first, the air cathode film was cut in the shape of a disk and the disk-shaped air cathode was overlaid on an aluminum grid (cathode collector) to be in contact therewith. Meanwhile, a Li foil was cut in the shape of a disk to form an anode and the disk-shaped anode was overlaid on a stainless-steel collector to be in contact therewith. Then, a glass ceramics separator (manufactured by Whatman Ltd.) is disposed between the air cathode and the anode to insulate the air cathode and the anode from each other. The glass ceramics separator of the thus-obtained laminate was impregnated with a nonaqueous electrolytic solution (propylene carbonate solution containing LiPF₆, LiPF₆ concentration: 1 M). The thus-obtained rechargeable lithium-air battery was stored in a case and the case was sealed hermetically. However, the aluminum grid (cathode collector) was exposed to supply oxygen to the air cathode.

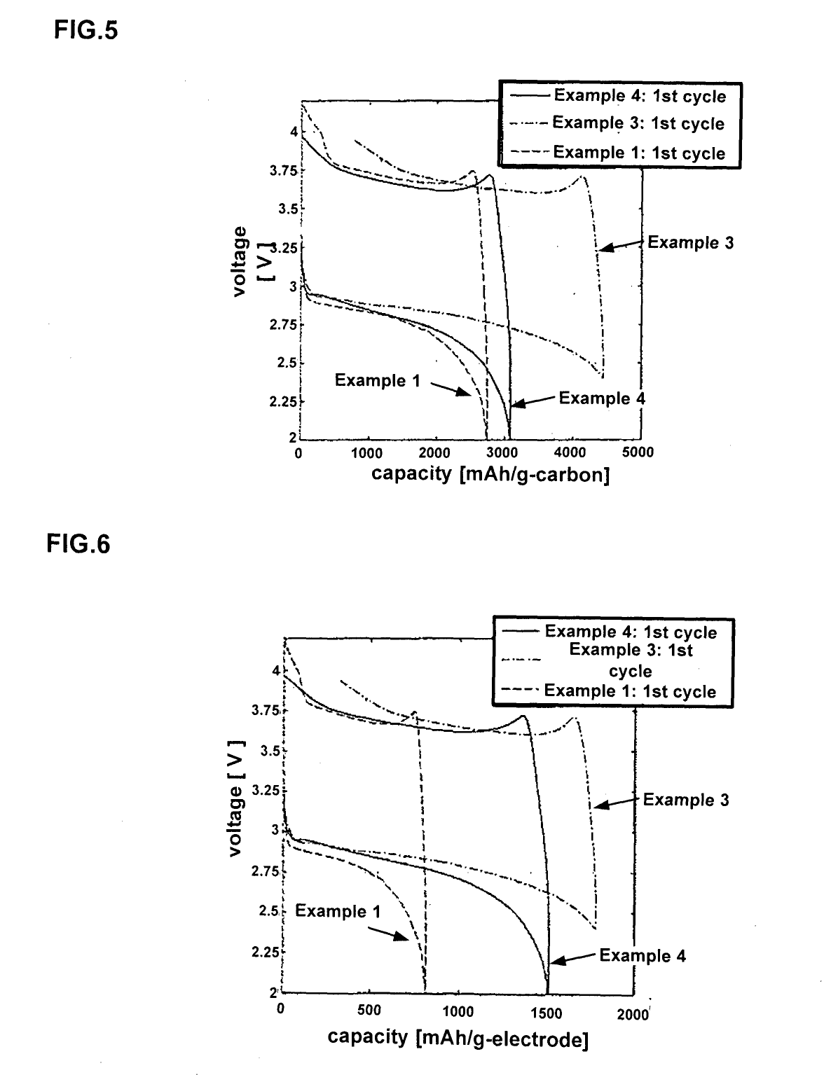

The rechargeable lithium-air battery thus produced was taken out from the globe box and placed in pure O₂ at 1 atm. was supplied to the air cathode for 30 minutes at a constant flow rate. Then, the rechargeable lithium-air battery was settled in O₂ at 1 atm to repeat charge and discharge cycles (charging rate and discharging rate: 70 mA/g, cut-off voltage: 2.0 to 3.9 V). FIGS. 5 and 6 show the charge-discharge voltage and capacity (1st cycle) of the rechargeable lithium-air battery of Examples 1, 3 and 4. Table 1 shows the discharge capacity (mAh/g-C and mAh/g-electrode) and overvoltage of the rechargeable lithium-air battery of Examples 1, 3 and 4 at the 1st cycle.

FIG. 5 shows the relationship between the charge-discharge voltage and the capacity in respect of the mass of the carbon (mAh/g-carbon) while FIG. 6 shows the relationship between the charge-discharge voltage and the capacity in respect of the mass of the air cathode (mAh/g-electrode). The capacity in respect of the mass of the air cathode was calculated by using the weight of the entire air cathode at the end of discharge.

The calculation method of capacity (mAh/g-electrode) is as follows:

Capacity (mAh/g-electrode)=Capacity (mAh/g-Carbon)*f_{c} where f_{c} is the weight fraction of the carbon in the final cathode material. In Example 1, f_{C}=0.47. In Example 3, f_{C}=0.40. In Example 4, f_{C}=0.34. Herein, f_{C} is different from the weight fraction of MnO₂ over the total of the weights of the carbon and MnO₂ (cathode catalyst) in the final cathode material.

TABLE 1

| | Example 1 | Example 3 | Example 4 |
|---|---|---|---|
| MnO₂ (wt %) | 25 | 37.6 | 47.2 |
| f_{C} | 0.47 | 0.40 | 0.34 |
| f_{MnO2} (—) | 0.25 | 0.376 | 0.472 |
| BETₜₒₜ (m²/g) | 118 | 141 | 159 |
| BET_{MnO2} (m²/g) | 286 | 272 | 266 |
| TEM Average Wire Diameter | 5 | 5 | 5 |
| (Short Axis Length) (nm) | | | |
| TEM Average Wire Length | 18 | 17 | 17 |
| (Long Axis Length) (nm) | | | |
| Overvoltage (V) | 0.9 | 0.85 | 0.9 |
| 1st Discharge Capacity | 2740 | 4440 | 3077 |
| (mAh/g-C) | | | |
| 1st Discharge Capacity | 1283 | 1776 | 1046 |
| (mAh/g-Electrode) | | | |

In the same manner as above, rechargeable lithium-air batteries were produced with the cathode materials of Examples 1, 3 and 4, respectively. Charge and discharge cycles of the batteries were repeated in the same manner as above except that the cut-off voltage was changed (Example 1: 2.4 to 4 V, Example 3: 2.4 to 4 V, Example 4: 2.0 to 3.9 V).

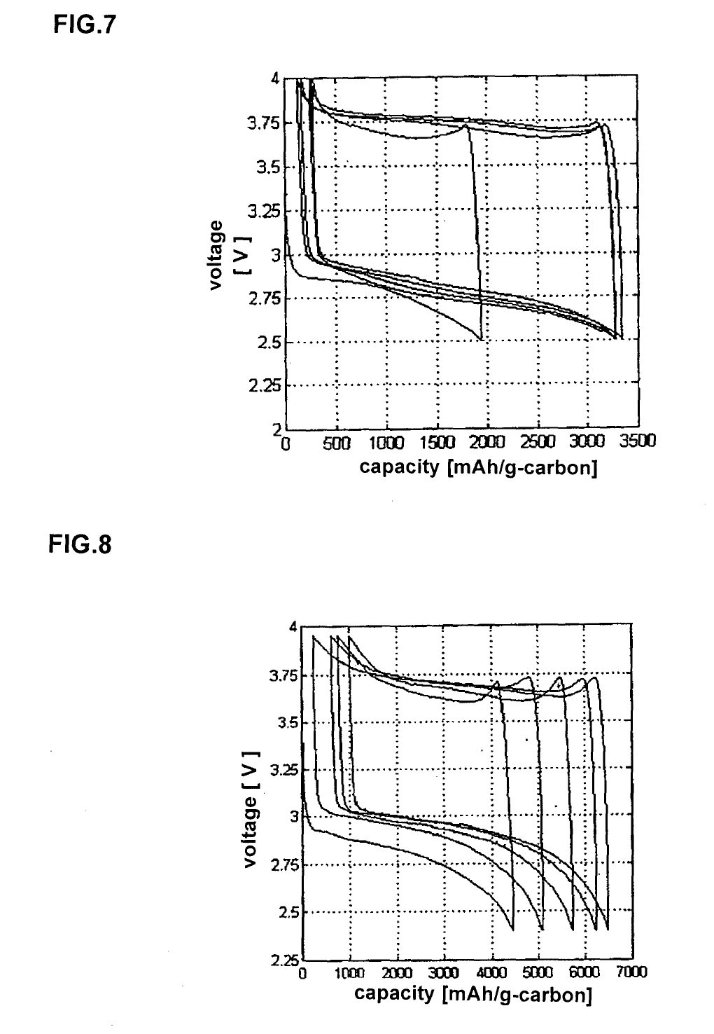

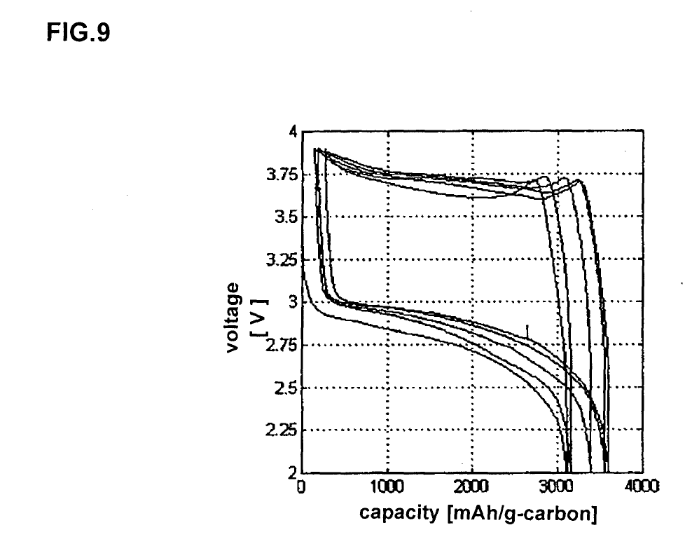

The results are shown in FIG. 7 (Example 1), FIG. 8 (Example 3) and FIG. 9 (Example 4). The capacity in FIGS. 7 to 9 is a capacity in respect of the mass of carbon (mAh/g-carbon).

FIGS. 5 and 6 show that the initial capacities of Examples 1, 3 and 4 are excellent and greater in the order of Example 1<Example 4<Example 3. FIGS. 7 to 9 also confirmed that the capacities of Examples 1, 3 and 4 are excellent and greater in the order of Example 1<Example 4<Example 3. However, the capacity retentions of Examples 1, 3 and 4 are excellent and greater in the order of Example 1<Example 3<Example 4 and Examples 4 showed the best cyclability.

### Comparative Examples 1

### (Production of Rechargeable Lithium-Air Battery)

A rechargeable lithium-air battery was produced in the same manner as above except that the slurry was produced by, as in Non-Patent Literature 3, the physical mixing of carbon (product name: Super P, manufactured by TIMCAL Ltd.), α-MnO₂ wires and a binder (a copolymer based on PVDF, product name: Kynar, manufactured by: Arkema Inc.) at a molar ratio of 95:2.5:2.5.

### (Evaluation of Rechargeable Lithium-Air Battery)

The rechargeable lithium-air battery thus produced was taken out from the globe box and placed in pure O₂ at 1 atm. was supplied to the air cathode for 30 minutes at a constant flow rate. Then, the rechargeable lithium-air battery was settled in O₂ at 1 atm to repeat charge and discharge cycles (charging rate and discharging rate: 70 mA/g, cut-off voltage: 2.0 to 3.9 V).

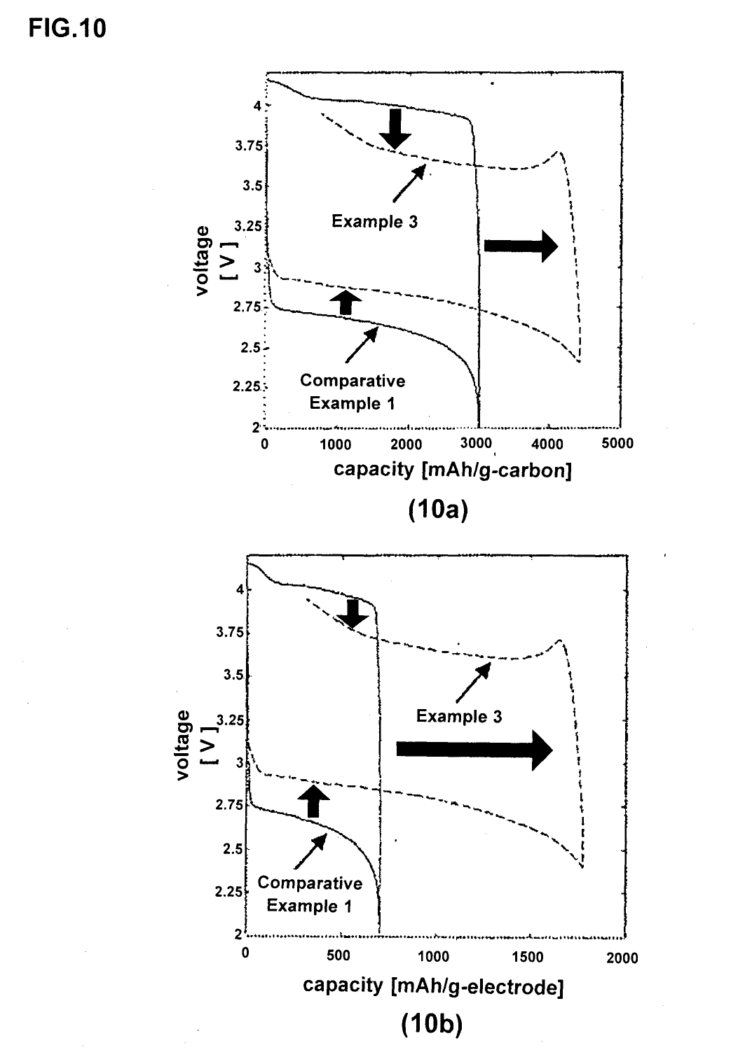

FIG. 10 shows the charge-discharge voltage and capacity (1st cycle) of the rechargeable lithium-air battery of Comparative Example 1. FIG. 10 also shows the results of Example 3 shown in FIGS. 5 and 6. FIG. 10 (10a) shows the relationship between the charge-discharge voltage and the capacity in respect of the mass of the carbon (mAh/g-carbon) while FIG. 10 (10b) shows the relationship between the charge-discharge voltage and the capacity in respect of the mass of the air cathode (mAh/g-electrode).

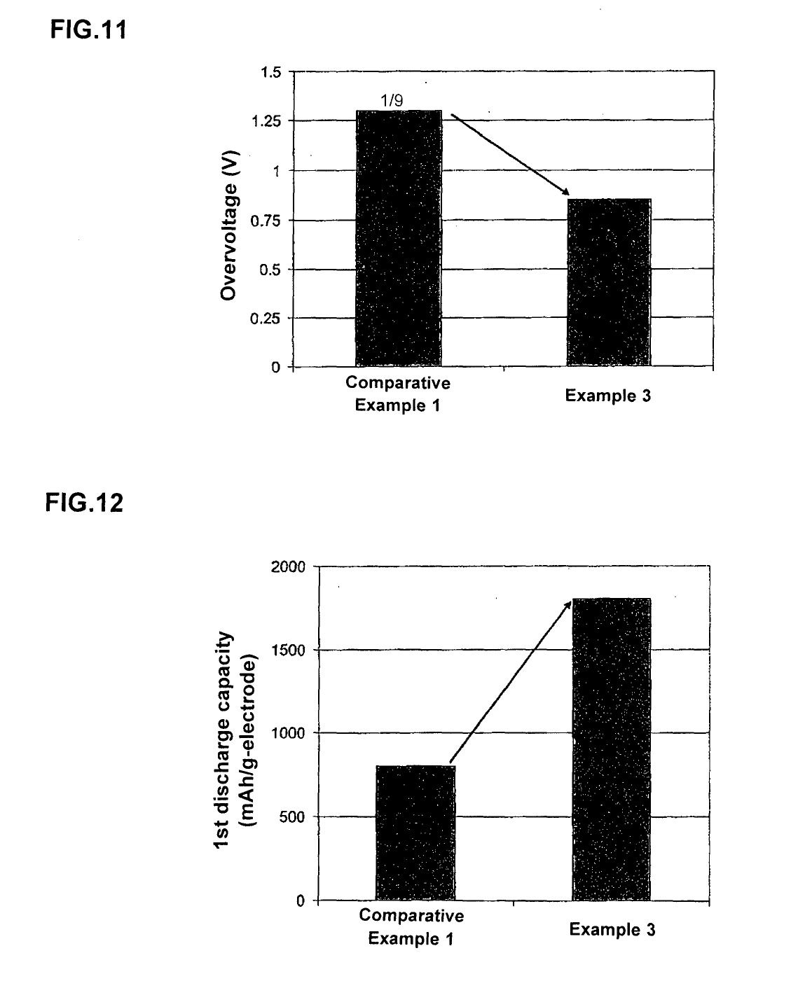

FIG. 10 shows that in Example 3, the discharging voltage was increased from 2.7 V to 2.9 V and the charging voltage was decreased from 4 V to 3.75 V, compared to Comparative Example 1. As shown in FIG. 11, while the lowest overvoltage is 1.3 V in Comparative Example 1, the overvoltage is 0.85 V in Example 3 and there is a great decrease. In addition, as shown in FIG. 12, Example 3 showed greater capacity performances than Comparative Example 1.

The reason why, as described above, Example 3 showed greater energy efficiency and capacity performances than Comparative Example 1 is assumed as follows.

While the cathode of the rechargeable lithium-air battery of Comparative Example 1 was produced with the slurry which was prepared by the mechanical mixing of α-MnO₂ and the carbon, the cathode of the rechargeable lithium-air battery of Example 3 was produced with the cathode material in which α-MnO₂ is directly loaded onto the surface of the carbon by synthesizing α-MnO₂ in the presence of the carbon. Therefore, compared to the cathode of Comparative Example 1, in the cathode of Example 3, the carbon and α-MnO₂ (catalyst) are in intimate contact with each other and, as shown in FIG. 4, fine α-MnO₂ is contained in a finely dispersed state. As a result, it is considered that compared to Comparative Example 1, the efficiency of catalyst activity in the rechargeable lithium-air battery of Example 3 is increased, so that the battery provides the same or greater capacity performances even though the amount of the catalyst is small, and the energy efficiency of the battery is increased.

### REFERENCE SIGHS LIST

1. Rechargeable lithium-air battery
2. Anode
3. Air cathode
4. Electrolyte
5. Anode collector
6. Air cathode collector

1. A method for producing a cathode material for rechargeable lithium-air batteries, which has a cathode catalyst loaded onto carbon, the method comprising:
a step of sonicating a mixed solution comprising a carbon having a specific surface area of 20 to 1,500 m²/g, a surfactant and a solvent, and
a step of in situ synthesis of the cathode catalyst by (1) adding a cathode catalyst raw material to the mixed solution and (2) adding a solution containing an oxidant to the mixed solution to cause in situ precipitation of the cathode catalyst onto the carbon, the catalyst having a wire form in which the short axis length is smaller than that of the carbon and is 2 to 50 nm and the long axis length is longer than that of the carbon and is 5 to 200 nm, wherein the synthesis step comprises:
a step of adsorbing a cathode catalyst metal ion on the carbon by adding a cathode catalyst metal salt to the mixed solution, and
a step of adding a cathode catalyst metal ion oxidant to the mixed solution after the adsorption step to oxidize the cathode catalyst metal ion.

2. (canceled)

3. The method for producing the cathode material according to claim 1, wherein the cathode catalyst is α-MnO₂.

4. A cathode material for rechargeable lithium-air batteries, which has a cathode catalyst loaded onto carbon,
wherein the cathode catalyst has a wire form in which the short axis length is smaller than that of the carbon and is to 10 nm and the long axis length is longer than that of the carbon and is 5 to 200 nm;
wherein the carbon has a specific surface area of 20 to 1,500 m2/g; and wherein the percentage of the weight of the cathode catalyst to the total of the weights of the carbon and cathode catalyst (“the weight of the cathode catalyst”/“the total of the weights of the carbon and cathode catalyst”) is 1% or more and 43% or less.

5. The cathode material according to claim 4, wherein the cathode catalyst is α-MnO₂.

6. The cathode material according to claim 4, wherein the percentage of the weight of the cathode catalyst is 38% or less.

7. The cathode material according to claim 4, wherein the specific surface area of the cathode material is 100 m²/g or more.

8. The cathode material according to claim 4, wherein the specific surface area of the cathode catalyst is 250 m²/g or more.

9. A rechargeable lithium-air battery comprising an anode, an air cathode and an electrolyte that is present therebetween,
wherein the air cathode comprises a cathode material produced by the method defined by claim 1.

10. A rechargeable lithium-air battery comprising an anode, an air cathode and an electrolyte that is present therebetween,
wherein the air cathode comprises the cathode material defined by claim 4.
